(19) United States
(12) Patent Application Publication
(10) Pub. No.: US 2003/0205978 A1
(43) Pub. Date: Nov. 6, 2003

(54) Apparatus for controlling extension and retraction of a shielding member

(76) Inventor: Pao-Chen Lee, Yung-Kang City (TW)

Correspondence Address: MORGAN, LEWIS & BOCKIUS LLP, 1111 Pennsylvania Avenue, NW, Washington, DC, 20004, US

(21) Appl. No.: 10/136,335

(22) Filed: May 2, 2002

(51) Int. Cl. H02P 1/00; H02P 3/00; G05B 5/00; H02P 7/00; H02H 7/08

(52) U.S. Cl. 318/445

(57) ABSTRACT

In an apparatus for controlling extension and retraction of a shielding member, a bi-directional motor has a drive shaft coupled to the shielding member. A processing unit is operable in a normal operating mode, where the processing unit controls the motor for moving a free end of the shielding member between predetermined extended and retracted positions based on extended and retracted position information stored in a memory. When supply of electric power to the apparatus is interrupted, the processing unit determines current position information from motor rotation signals provided by a sensor unit such that the processing unit is able to automatically control the motor for moving the free end of the shielding member when supply of the electric power to the apparatus is resumed.

### BACKGROUND OF THE INVENTION

1. Field of the Invention

The invention relates to a shielding member, more particularly to an apparatus for controlling extension and retraction of a shielding member.

2. Description of the Related Art

In U.S. Pat. No. 6,283,190 B1, entitled “PROGRAMMABLE WINDOW BLIND ASSEMBLY”, there is disclosed an apparatus for controlling extension and retraction of a shielding member. The conventional programmable window blind assembly includes a window blind device having a pull cord unit connected operably to a blind unit. A motor drive unit includes a bi-directional motor that has a drive shaft coupled to the pull cord unit such that rotation of the drive shaft can result in movement of the blind unit. A sensor unit generates motor rotation signals for indicating angular speed and angular displacement of the drive shaft. A programmable data storage device has blind position information stored therein. A processor controls the motor to operate in a first direction for moving the blind unit to a retracted position and in a second direction for moving the blind unit to an extended position. The processor is operable in a normal operating mode, where, based on the position information stored in the data storage device and the motor rotation signals from the sensor unit, the processor terminates operation of the motor in the first direction upon determining that the blind unit has reached the retracted position, and terminates operation of the motor in the second direction upon determining that the blind unit has reached the extended position.

However, when supply of electric power to the conventional programmable window blind assembly is interrupted, proper operation of the conventional programmable window blind assembly cannot be ensured due to lack of current position information of the blind unit when supply of the electric power to the conventional programmable window blind assembly is resumed, thereby resulting in inconvenience during use.

### SUMMARY OF THE INVENTION

Therefore, the object of the present invention is to provide an apparatus for controlling extension and retraction of a shielding member, which can automatically move the shielding member to a predetermined extended or retracted position when supply of electric power to the apparatus is resumed so as to ensure proper operation of the apparatus.

According to the present invention, there is provided an apparatus for controlling extension and retraction of a shielding member having a coupling end and a free end opposite to the coupling end. The apparatus comprises:

a motor drive unit including a bi-directional motor that has a drive shaft adapted to be coupled to the coupling end of the shielding member such that rotation of the drive shaft can result in movement of the free end of the shielding member between a predetermined extended position and a predetermined retracted position;

a sensor unit associated operably with the drive shaft of the motor, the sensor unit generating motor rotation signals for indicating angular rotation of the drive shaft;

a memory for storing extended position information and retracted position information therein;

a power supply unit for supplying electric power to the apparatus, the power supply unit having a backup storage device that is charged during a normal power supplying state of the power supply unit;

a regulating circuit connected to the power supply unit for receiving a power signal therefrom and for generating a regulated output having an operating voltage, the backup storage device discharging during a power interrupted state of the power supply unit such that the operating voltage of the regulated output of the regulating circuit is gradually reduced as compared to that during the normal power supplying state of the power supply unit; and

a processing unit connected to the sensor unit, the memory, the motor drive unit and the regulating circuit, the processing unit controlling the motor to operate in a first direction for moving the free end of the shielding member to the predetermined retracted position and in a second direction for moving the free end of the shielding member to the predetermined extended position.

The processing unit is operable in a normal operating mode, where the processing unit terminates operation of the motor in the first direction upon determining that the free end of the shielding member has reached the predetermined retracted position based on the retracted position information stored in the memory and the motor rotation signals from the sensor unit, and where the processing unit terminates operation of the motor in the second direction upon determining that the free end of the shielding member has reached the predetermined extended position based on the extended position information stored in the memory and the motor rotation signals from the sensor unit,

Upon detection by the processing unit of the gradual reduction in the operating voltage of the regulated output of the regulating circuit, indicative of the power interrupted state of the power supply unit, the processing unit determines current position information from the motor rotation signals monitored during movement of the free end of the shielding member from one of the predetermined extended and retracted positions to a current position and storing the current position information in the memory such that the processing unit is able to automatically control the motor for moving the free end of the shielding member from the current position to the other one of the predetermined extended and retracted positions based on the retracted and extended position information and the current position information when the normal power supplying state of the power supply unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view showing the first preferred embodiment of an apparatus for controlling extension and retraction of a shielding member according to the present invention;

FIG. 2 is a schematic circuit block diagram illustrating the first preferred embodiment;

FIG. 3 is a schematic view illustrating a motor drive unit and a sensor unit of the first preferred embodiment; and

FIG. 4 is a schematic circuit block diagram illustrating the second preferred embodiment of an apparatus for controlling extension and retraction of a shielding member according to the present invention.

### DETAILED DESCRIPTION OF THE PREFERRED EMBODIMENTS

Before the present invention is described in greater detail, it should be noted that like elements are denoted by the same reference numerals throughout the disclosure.

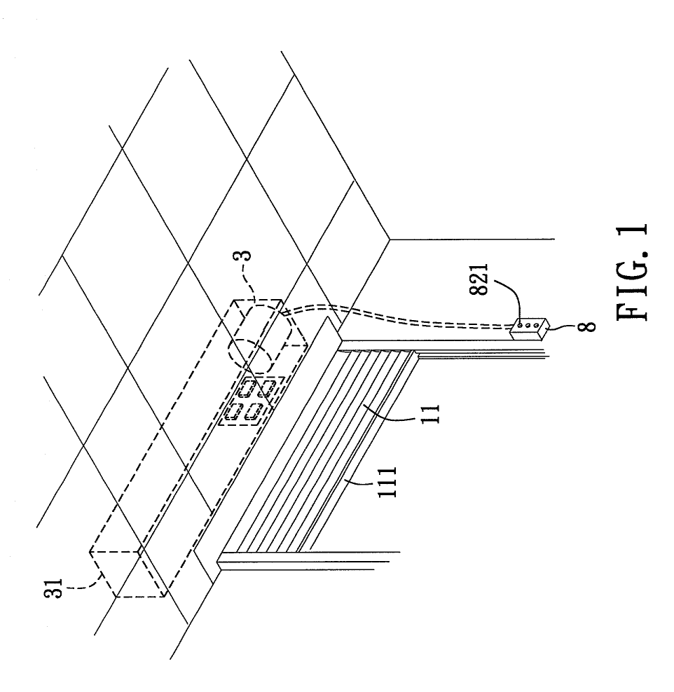

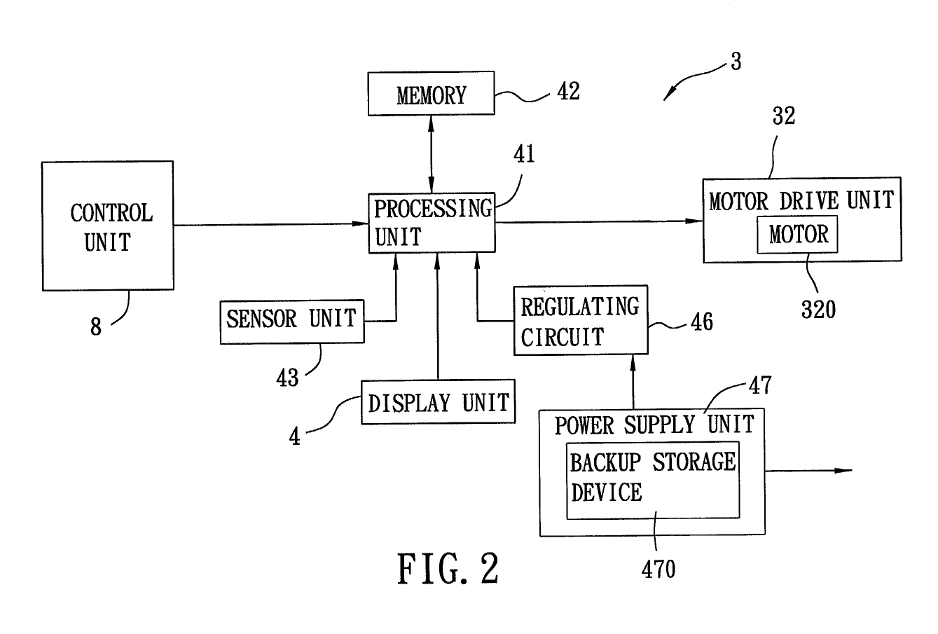

Referring to FIGS. 1, 2 and 3, the first preferred embodiment of an apparatus 3 for controlling extension and retraction of a shielding member according to the present invention is shown to include a motor drive unit 32, a sensor unit 43, a memory 42, a power supply unit 47, a regulating circuit 46, a processing unit 41, and a control unit 5. In this embodiment, the shielding member is in the form of a rolling door 11 that has a coupling end (not shown) and a free end 111 opposite to the coupling end.

The motor drive unit 32 includes a bi-directional motor 320, which is mounted on a top housing 31 (see FIG. 1), and which has a drive shaft 321 adapted to be coupled to the coupling end of the rolling door 11 such that rotation of the drive shaft 321 can result in movement of the free end 111 of the rolling door 11 between a predetermined extended position and a predetermined retracted position via a drive gear 322 mounted on and co-rotatable with the drive shaft 321.

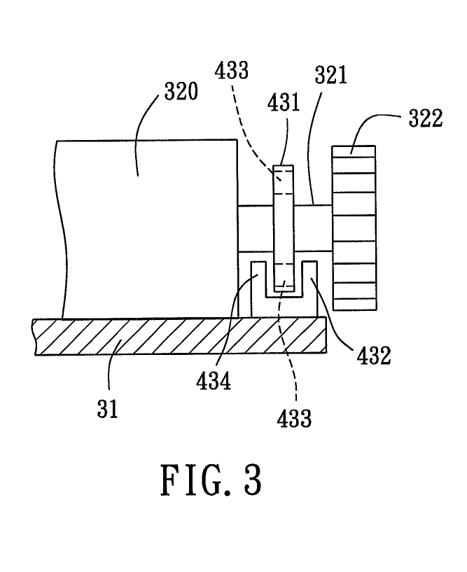

The sensor unit 43 is associated operably with the drive shaft 321 of the motor 320, and generates motor rotation signals for indicating angular rotation of the drive shaft 321. In this embodiment, as shown in FIG. 3, the sensor unit 43 is in the form of a photo-sensing unit that includes a photo emitter 432 mounted on the top housing 31, a photo receiver 434 mounted on the top housing 31 and spaced apart from the photo emitter 432 so as to define a light path therebetween, and a slotted photo interrupting wheel 431 co-rotatable with the drive shaft 321 and disposed in the light path between the photo emitter 432 and the photo receiver 434 so as to interrupt periodically the light path to result in the motor rotation signals at the photo receiver 434. The slotted photo interrupting wheel 431 is formed with a plurality of angularly displaced slots 433 and extends into the light path between the photo emitter 432 and the photo receiver 434 to interrupt periodically the light path according to rotation of the drive shaft 321.

The memory 42 stores extended position information and retracted position information therein, which will be described in greater detail hereinafter.

The power supply unit 47 supplies electric power to the apparatus 3, and has a backup storage device 470, such as a capacitor, that is charged during a normal power supplying state of the power supply unit 47.

The regulating circuit 46 is connected to the power supply unit 47 for receiving a power signal therefrom and for generating a regulated output having an operating voltage. During a power interrupted state of the power supply unit 47, the backup storage device 470 discharges such that the operating voltage of the regulated output of the regulating circuit 46 is gradually reduced as compared to that during the normal power supplying state of the power supply unit 47.

The processing unit 41 is connected to the sensor unit 43, the memory 42, the motor drive unit 32, and the regulating circuit 6. The processing unit 41, which is supplied with electric power via the regulating circuit 46, controls the motor 320 to operate in a first direction for moving the free end 111 of the rolling door 11 to the predetermined retracted position and in a second direction for moving the free end 111 of the rolling door 11 to the predetermined extended position. The processing unit 41 is operable in a normal operating mode, where the processing unit terminates operation of the motor 320 in the first direction upon determining that the free end 111 of the rolling door 11 has reached the predetermined retracted position based on the retracted position information stored in the memory 42 and the motor rotation signals from the sensor 43, and where the processing unit 41 terminates operation of the motor 320 in the second direction upon determining that the free end 111 of the rolling door 11 has reached the predetermined extended position based on the extended position information stored in the memory 41 and the motor rotation signals from the sensor unit 43.

In the apparatus 3 of this invention, upon detection by the processing unit 41 of the gradual reduction in the operating voltage of the regulated output of the regulating circuit 46, indicative of the power interrupted state of the power supply unit 47, the processing unit 41 determines current position information from the motor rotation signals monitored during movement of the free end 111 of the rolling door 11 from one of the predetermined extended and retracted positions to a current position and stores the current position information in the memory 42 such that the processing unit 41 is able to automatically control the motor 320 for moving the free end 111 of the rolling door 11 from the current position to the other one of the predetermined extended and retracted positions based on the retracted and extended position information and the current position information when the normal power supplying state of the power supply unit 47 is resumed, thereby overcoming the aforesaid drawback of the prior art described beforehand.

In addition, the processing unit 41 is further operable in a user-defined mode, where the processing unit 41 determines designated retracted position information by operating the motor 320 in the first direction to move the free end 111 of the rolling door 11 from the predetermined extended position to a designated retracted position, by monitoring adjust control signals received thereby to determine if the free end 111 of the rolling door 11 has reached the designated retracted position, and by monitoring the motor rotation signals from the sensor unit 43 during movement of the free end 111 of the rolling door 11 from the predetermined extended position to the designated retracted position, and where the processing unit 41 determines designated extended position information by operating the motor 320 in the second direction to move the free end 111 of the rolling door 11 from the predetermined retracted position to a designated extended position, by monitoring the adjust control signals received thereby to determine if the free end 111 of the rolling door 11 has reached the designated extended position, and by monitoring the motor rotation signals from the sensor unit 43 during movement of the free end 111 of the rolling door from the predetermined retracted position to the designated extended position. The processing unit 41 further stores the designated retracted and extended position information determined thereby in the memory 41. The designated retracted and extended position information replace the retracted and extended position information previously stored in the memory 41.

In this embodiment, the control unit 8 is connected to the processing unit 41, and is provided with a plurality of control keys 821 (see FIG. 1) that are manually operable so as to enable the processing unit 41 to operated in a selected one of the normal operating mode and the user-defined mode and so as to provide the adjust control signals to the processing unit 41.

The apparatus 3 further includes a display unit 44 connected to the processing unit 41 for indicating the mode of operation of the processing unit 41. The display unit 44 can include a plurality of LEDs (not shown).

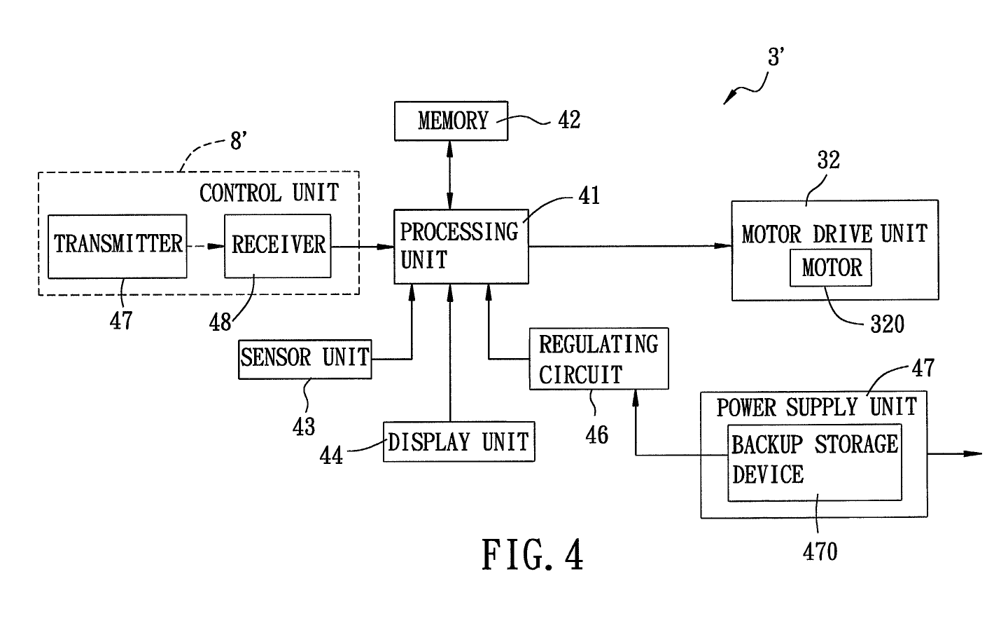

FIG. 4 illustrates the second preferred embodiment of an apparatus 3′ for controlling extension and retraction of a shielding member according to this invention, which is a modification of the first preferred embodiment. Unlike the previous embodiment, the control unit 8′ includes a transmitter 47 which is manually operable so as to wirelessly transmit the adjust control signals, and a receiver 48 which receives the adjust control signals from the transmitter 47 and which provides the adjust control signals received thereby to the processing unit 41.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An apparatus for controlling extension and retraction of a shielding member having a coupling end and a free end opposite to the coupling end, said apparatus comprising:
a motor drive unit including a bi-directional motor that has a drive shaft adapted to be coupled to the coupling end of the shielding member such that rotation of said drive shaft can result in movement of the free end of the shielding member between a predetermined extended position and a predetermined retracted position;
a sensor unit associated operably with said drive shaft of said motor, said sensor unit generating motor rotation signals for indicating angular rotation of said drive shaft;
a memory for storing extended position information and retracted position information therein;
a power supply unit for supplying electric power to said apparatus, said power supply unit having a backup storage device that is charged during a normal power supplying state of said power supply unit;
a regulating circuit connected to said power supply unit for receiving a power signal therefrom and for generating a regulated output having an operating voltage, said backup storage device discharging during a power interrupted state of said power supply unit such that the operating voltage of the regulated output of said regulating circuit is gradually reduced as compared to that during the normal power supplying state of said power supply unit; and
a processing unit connected to said sensor unit, said memory, said motor drive unit and said regulating circuit, said processing unit controlling said motor to operate in a first direction for moving the free end of the shielding member to the predetermined retracted position and in a second direction for moving the free end of the shielding member to the predetermined extended position,
wherein said processing unit is operable in a normal operating mode, where said processing unit terminates operation of said motor in the first direction upon determining that the free end of the shielding member has reached the predetermined retracted position based on the retracted position information stored in said memory and the motor rotation signals from said sensor unit, and where said processing unit terminates operation of said motor in the second direction upon determining that the free end of the shielding member has reached the predetermined extended position based on the extended position information stored in said memory and the motor rotation signals from said sensor unit,
upon detection by said processing unit of the gradual reduction in the operating voltage of the regulated output of said regulating circuit, indicative of the power interrupted state of said power supply unit, said processing unit determining current position information from the motor rotation signals monitored during movement of the free end of the shielding member from one of the predetermined extended and retracted positions to a current position and storing the current position information in said memory such that said processing unit is able to automatically control said motor for moving the free end of the shielding member from the current position to the other one of the predetermined extended and retracted positions based on the retracted and extended position information and the current position information when the normal power supplying state of said power supply unit is resumed.

2. The apparatus as claimed in claim 1, wherein said processing unit is further operable in a user-defined mode, where said processing unit determines designated retracted position information by operating said motor in the first direction to move the free end of the shielding member from the predetermined extended position to a designated retracted position, by monitoring adjust control signals received thereby to determine if the free end of the shielding member has reached the designated retracted position, and by monitoring the motor rotation signals from said sensor unit during movement of the free end of the shielding member from the predetermined extended position to the designated retracted position, and where said processing unit determines designated extended position information by operating said motor in the second direction to move the free end of the shielding member from the predetermined retracted position to a designated extended position, by monitoring the adjust control signals received thereby to determine if the free end of the shielding member has reached the designated extended position, and by monitoring the motor rotation signals from said sensor unit during movement of the free end of the shielding member from the predetermined retracted position to the designated extended position, said processing unit further storing the designated retracted and extended position information determined thereby in said memory, the designated retracted and extended position information replacing the retracted and extended position information previously stored in said memory.

3. The apparatus as claimed in claim 2, further comprising a control unit connected to said processing unit and manually operable so as to enable said processing unit to operate in a selected one of the normal operating mode and the user-defined mode and so as to provide the adjust control signals to said processing unit.

4. The apparatus as claimed in claim 1, wherein electric power is supplied to said processing unit via said regulating circuit.
